(19) United States
(12) Patent Application Publication
(10) Pub. No.: US 2020/0104806 A1
(43) Pub. Date: Apr. 2, 2020

(54) COLLECTING SYSTEM FOR OLD PAPER RECYCLABLE RESOURCES

(71) Applicants: Jaesung CHO, (US); Soonsung CHO, (US); Hiroshi TAKEMOTO, (US); Ryoko TAKEMOTO, (US)

(72) Inventor: Jaesung CHO, Suzaka-shi, Nagano (JP)

(21) Appl. No.: 16/347,680

(22) PCT Filed: Aug. 31, 2018
(86) PCT No.: PCT/JP2018/032412

§ 371 Date: May 6, 2019

(51) Int. Cl. G06Q 10/00; G06Q 20/38; G06Q 20/20; B65B 13/18

(52) U.S. Cl. CPC G06Q 10/30; B65B 13/18; G06Q 20/208; G06Q 20/387

(57) ABSTRACT

To increase an incentive to bind old paper recyclable resources with paper string, to save trouble for a paper maker and to prevent garbage generation of vinyl string, thereby promoting a natural-circulation recycle system. As a solution, a system includes a portable terminal (12) possessed by a consumer (10), a weight sensor for measuring the weight of old paper recyclable resources (22) taken out by the consumer, a consumer data reading device reading consumer data (24) for specifying the consumer that is affixed to the old paper recyclable resources (22) and a paper string detection device detecting whether the old paper recyclable resources (22) taken out by the consumer are bound with a special paper string (21) with a special color or a special pattern, in which discount value data whereby a purchasing price is capable of being discounted when the consumer purchases any given product made by using recycled paper is calculated based on weight data, and the calculated discount value data is transmitted to the portable terminal (12) of a corresponding consumer.

### TECHNICAL FIELD

The present invention relates to a collecting system for old paper recyclable resources such as milk cartons.

### BACKGROUND ART

It is hitherto common that, as a method of collecting old paper recyclable resources generated from home or offices, old paper recyclable resources are tied with string and carried to a collection place previously designated in each region to be collected by a collection trader.

For example, there is disclosed a method in Patent Literature 1, in which old paper recyclable resources such as old newspaper, old magazines and leaflets are housed in a bag to which vinyl string is previously attached and carried to the collection place with the bag.

### CITATION LIST

### Patent Literature

PTL 1: Japanese Utility Model No. 3092000

### SUMMARY OF INVENTION

### Technical Problem

In the collection trader collecting old paper recyclable resources, a person who delivers old paper recyclable resources to a paper maker carries the resources to the paper maker. In the paper maker, the old paper recyclable resources are dissolved to manufacture recycled paper. The manufactured recycled paper is sold to respective traders.

Incidentally, regarding the old paper recyclable resources bound with the vinyl string, it is necessary to untie the string by the person who delivers the resources to the paper maker to obtain paper with no string to be recycled. There is a problem that untying the vinyl string is extremely troublesome and it is desirable to manufacture recycled paper without trouble.

Moreover, as a large amount of vinyl string becomes garbage when the vinyl string of the old paper recyclable resources bound with the vinyl string is untied, there is another problem that it is difficult to discard the vinyl string becoming garbage.

When the method such as in Patent Literature 1 is adopted, bags also become garbage in addition to the vinyl string, therefore, there is further another problem that it is difficult to discard the bags.

The present invention has been accomplished in view of the above problems and an object thereof is to provide a system capable of manufacturing recycled paper so as not to generate new garbage and without trouble with no use of vinyl string when recycling old paper recyclable resources and capable of suppressing depletion of natural resources as raw material of vinyl by suppressing use of vinyl string.

### Solution to Problem

In order to achieve the above object, the present invention has the following structures.

That is, a collecting system for old paper recyclable resources according to the present invention includes a portable terminal possessed by a consumer, a determination device for old paper recyclable resources having a weight sensor possessed by a collection trader of old paper recyclable resources for measuring the weight of old paper recyclable resources taken out by the consumer, a consumer data reading device reading consumer data for specifying the consumer that is affixed to the old paper recyclable resources taken out by the consumer, a paper string detection device detecting whether the old paper recyclable resources taken out by the consumer are bound with a special paper string with a special color or a special pattern and a data transmission device, a server device connected to the portable terminal and the determination device for old paper recyclable resources so as to communicate and a POS system installed in a retailer, in which, when detecting that the old paper recyclable resources are bound with the special paper string by the paper string detection device, the determination device for old paper recyclable resources reads consumer data for at least specifying the consumer by the consumer data reading device and transmits weight data of old paper recyclable resources read by the weight sensor and consumer data read by the consumer data reading device to the server device so as to be associated with each other by the data transmission device, the server device includes a storage device storing consumer data and weight data transmitted from the determination device for old paper recyclable resources so as to be associated with each other, a discount value calculating function calculating discount value data whereby a purchasing price is capable of being discounted when the consumer purchases any given product made by using recycled paper based on weight data, and a discount value data transmission device transmitting discount value data calculated by the discount value calculating function to the portable terminal of a corresponding consumer, and the POS system reads recycled paper use information when the consumer purchases any given product made by using recycled paper to which the recycled paper use information is attached as well as reads discount value data transmitted to the portable terminal possessed by the consumer to thereby operate to make a discount on a purchase amount of the product to which recycled paper use information is attached based on the discount value data.

According to the above configuration, the collection trader of old paper recyclable resources, when collecting old paper recyclable resources bound by using the special string, measures the weight of the old paper recyclable resources and specifies the consumer who has taken out the old paper recyclable resources. Then, the server device calculates a discount value capable of being used by the corresponding consumer at the time of purchasing any given product based on the weight of old paper recyclable resources transmitted from the collection trader. In this case, the given products are products made by using recycled paper, to which recycled paper use information is attached by, for example, barcodes (including QR codes (trademark) and the like). When the consumer purchases the product made by using recycled paper, the consumer can purchase the applicable product at a discounted price by discount value data to be read by the POS system.

Accordingly, the consumer can purchase the products made by using recycled paper at low price by using the paper string at the time of binding old paper recyclable resources, therefore, an incentive to use the paper string can be obtained. Moreover, when old paper recyclable resources are bound with paper string, useless garbage is not generated from the paper maker and trouble of untying the bounding is thereby saved at the time of manufacturing recycled paper.

Furthermore, the given products may include the special paper string.

### Advantageous Effects of Invention

When adopting the system for old paper recyclable resources according to the present invention, the incentive to bind old paper recyclable resources with paper string is increased, trouble for the paper maker is saved and garbage generation of vinyl string is suppressed to thereby promote a natural-circulation recycle system.

### BRIEF DESCRIPTION OF DRAWINGS

FIG. 1 is an explanatory view showing the entire configuration of a collecting system for old paper recyclable resources;

FIG. 2 is a block diagram showing a configuration of a server device;

FIG. 3 is a block diagram showing a configuration of a determination device for old paper recyclable resources; and

FIG. 4 is a block diagram showing a configuration of a POS system.

### DESCRIPTION OF EMBODIMENTS

Hereinafter, preferred embodiments of the present invention will be explained in detail with reference to the drawings.

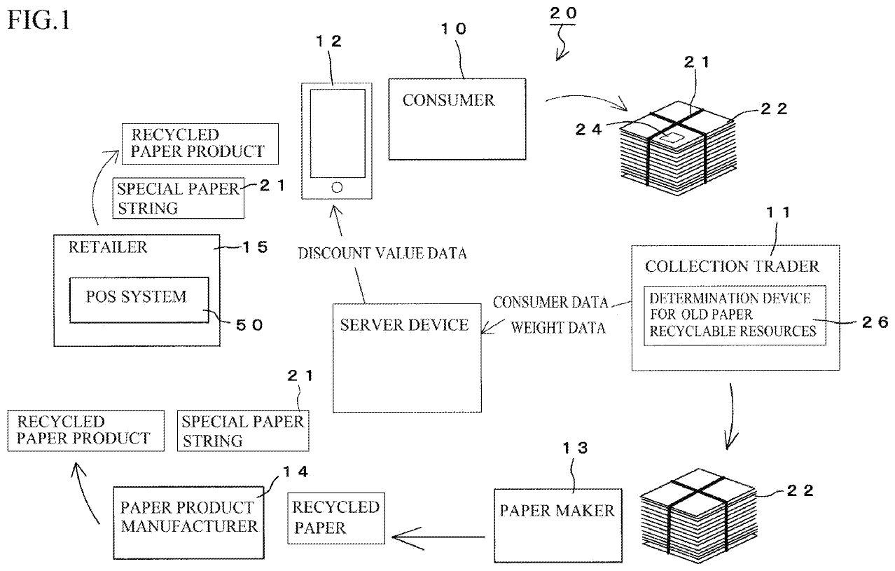

FIG. 1 shows the entire configuration of a collecting system for old paper recyclable resources.

A collecting system for old paper recyclable resources 20 is a system capable of saving trouble for a paper maker and preventing garbage from being newly generated by using paper string at the time of collecting old paper recyclable resources to thereby recycle resources positively.

In the collecting system for old paper recyclable resources 20, old paper recyclable resources 22 (paper such as newspaper, magazines, leaflets and milk cartons) taken out by a consumer 10 are bound with a special paper string 21 with a special color or a special pattern applied.

As the special color, it is preferable to adopt a color which is not used as a color for normal paper string such as green. As the special pattern, a pattern not used for normal paper string such as a stripe pattern of green and red is preferably used.

The consumer 10 affixes a consumer data 24 for specifying the consumer to the old paper recyclable resources 22 when taking out the old paper recyclable resources 22.

In the consumer data 24, a name of the consumer and contact information such as an email address or a telephone number of a portable terminal 12 possessed by the consumer are written.

To directly write the name and contact information of the consumer in the consumer data 24 is not preferable as problems such as leakage of personal information may occur. Accordingly, it is preferable to adopt the consumer data 24 which is coded into a barcode or a QR code.

The consumer 10 binds the old paper recyclable resources 22 with the special paper string 21 and takes them to a collection point for old paper recyclable resources with the consumer data 24 affixed thereto. The collection point is designated in each area. However, it is also possible to directly carry the paper to a collection trader 11 when taking out of the old paper recyclable resources 22.

The collection trader 11 measures the weight of the old paper recyclable resources 22 taken out by the consumer 10. The collection trader 11 also reads the consumer data 24 affixed to the old paper recyclable resources 22.

After the weight of the old paper recyclable resources 22 taken out by each consumer 10 is measured by the collection trader 11, the collection trader 11 stores the weight of old paper recyclable resources for each consumer in a server device 30.

However, the collection trader 11 does not measure the weight of old paper recyclable resources not bound with the special paper string 21.

That is because it is possible to prevent generation of useless waste in the paper maker by binging the resources with the special paper string 21 and a discount given to the consumer by using the special paper string 21 serves as an incentive.

The server device 30 is provided for controlling the entire system of the present embodiment, which can be connected to Internet.

In a storage device 36 of the server device 30, the name of the consumer, contact information (an email address or a telephone number of the portable terminal 12 possessed by the consumer) and the weight of the old paper recyclable resources are previously stored.

The server device 30 is also provided with an operation processor, and discount value data corresponding to each weight of old paper recyclable resources of each consumer is calculated by the operation processor.

The server device 30 transmits the discount value data calculated for each consumer to the portable terminal 12 of each consumer 10.

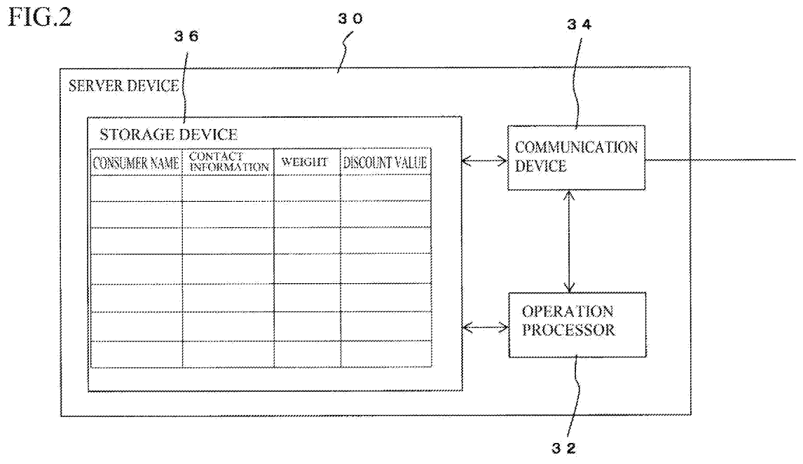

FIG. 2 shows an internal configuration of the server device 30.

A common server computer can be adopted as the server device 30, including an operation processor 32 configured by a CPU, a memory and so on, a communication device 34 which can be connected to Internet and the storage device 36 configured by a hard disk, a SSD or the like.

The storage device 36 stores the weight of old paper recyclable resources taken out by the consumer so as to be associated with the name of the consumer and contact information of the consumer. A discount value is calculated by the operation processor 32 based on the weight. The discount value is like a discount coupon used when the consumer buys something, which is given when the consumer takes out the old paper recyclable resources 22 in a state of being bound with the special paper string 21.

The operation processor 32 has a discount value calculation function, and a discount value calculated by the discount value calculation function may be calculated based on the weight of old paper recyclable resources taken out during a certain period (for example, a month). It is necessary to set a relational expression between the weight and the discount value in advance. For example, a discount value of 100 yen is obtained in a case where the old paper recyclable resources 22 of 1 kg are bound with the special paper string 21 during a month.

The discount value calculated by the operation processor 32 is stored in the storage device 36 as data for each consumer.

The server device 30 transmits the calculated discount value to the contact information of the consumer (the email address or a SMS mail of a telephone number of the portable terminal 12 possessed by the consumer) as data.

The consumer 10 can receive discount service by producing the discount value data at the time of shopping after receiving the discount value data.

The discount value data is coded into a barcode or a QR code in the portable terminal 12 possessed by the consumer 10 and stored in the storage device of the portable terminal 12.

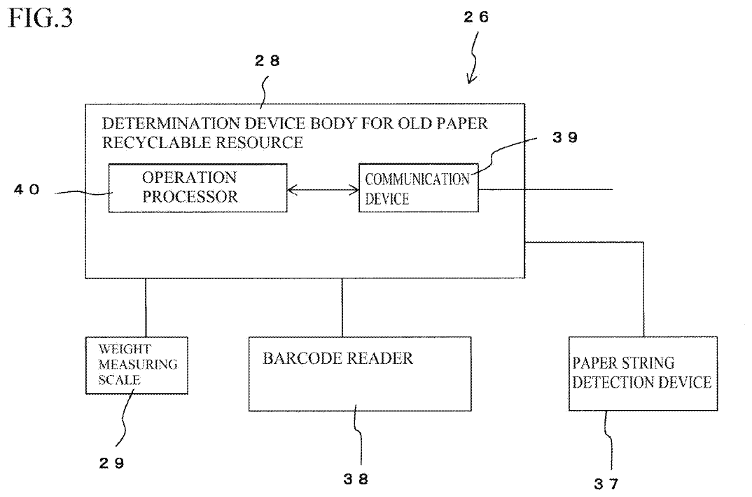

FIG. 3 shows an internal configuration of a determination device for old paper recyclable resources 26 used by the collection trader 11.

Measurement of the old paper recyclable resources 22 is executed by the determination device for old paper recyclable resources 26.

The determination device for old paper recyclable resources 26 is provided with a determination device body 28 configured by a common computer or the like, a weight measuring scale 29 connected to the body 28 and measuring the weight of the old paper recyclable resources 22, a barcode reader 38 connected to the body 28 and reading the consumer data 24, a paper string detection device 37 determining whether paper string used for the binding is the special paper string or not and a monitor 41.

The determination device body 28 includes a communication device 39 capable of being connected to Internet and an operation processor 40 configured by a CPU, a memory and the like.

The paper string detection device 37 is configured by a CCD camera, and a taken image is transmitted to the operation processor 40 in the determination device body 28. In the operation processor 40, whether the taken image of the string corresponds to the special paper string or not is determined.

The determination concerning whether the image corresponds to the special paper string or not is performed by previously storing a color feature of the special paper string 21 in the operation processor 40 to determine whether the taken image of the string corresponds to the special paper string 21 or not.

The operation processor 40 controls the monitor 41 to display a result concerning whether the image corresponds to the special paper string 21 or not.

As whether the string is the special paper string or not is determined by the paper string detection device 37 as described above, it is possible to prevent consumers from gaining a profit by falsifying the special paper string.

The collection trader 11 does not use the paper string detection device 37 when it is possible to visually determine that the old paper recyclable resources 22 are obviously not bound with the special paper string 21, executing normal collection work as it is also not necessary to measure the weight.

Concerning the old paper recyclable resources 22 determined to be bounded with the special paper string 21 by the paper string detection device 37, the collection trader 11 operates the determination device for old paper recyclable resources 26 to measure the weight by the weight measuring scale 29 and read the consumer data 24 by the barcode reader 38.

The operation processor 40 transmits the measured weight value and the read consumer name and contact information which are associated with each other to the server device 30 through the communication device 39.

On the server device 30 side having received the above, the weight is stored in a field corresponding to the consumer name when the same consumer name and contact information already exist in a database of the storage device 36. If the consumer name is new, a new field is created in the database in the storage device 36, in which the consumer name, contact information and the weight are stored in the server device 30.

In FIG. 1, the collection trader 11 carries the collected old paper recyclable resources 22 to a paper maker 13. The collection trader 11 may directly carry the resources or a forwarding agent may carry the resources.

The paper maker 13 unties the special paper string 21 used for binding the old paper recyclable resources 22 and recycles the untied special paper string 21 and the old paper recyclable resources. Even when string used for binging the old paper recyclable resources is paper string other than the special paper string 21, the paper maker recycles the string as paper.

In a case where string used for binding the old paper recyclable resources 22 is made of a material other than paper string, the paper maker 13 disposes of the untied string as other garbage.

The collection trader 11 or the forwarding agent may untie the string used for binding the old paper recyclable resources 22.

The paper maker 13 allows the collected old paper recyclable resources and the untied paper string (including paper string other than the special paper string) to be infiltrated with chemicals to thereby remove ink from fibers to be in a mushy state to manufacture waste paper pulp.

The waste paper pulp is directly used for recycled paper or used for recycled paper after being mixed with new paper pulp.

The paper maker 13 sells the manufactured recycled paper to a paper product manufacturer 14 manufacturing paper products.

The paper product manufacturer 14 includes a paper string manufacturer. The paper string manufacturer manufactures the special paper string 21 by using waste paper pulp.

The paper product manufacturer 14 sells the manufactured recycled paper products (including the special paper string 21) to a retailer 15 through a wholesaler or directly.

As for the paper maker 13, when old paper recyclable resources to be bound with paper string are increased, costs for disposing of garbage such as vinyl string can be reduced, and further, the price of recycled paper itself can be reduced as compared with the past as the paper string can be also used as a raw material for recycled paper.

An amount of reduction in price can be allotted to a discount amount determined by discount value data of the consumer 10. Moreover, sales for manufacture of the special paper string 21 ought to be increased as compared with the past, therefore, it is possible to arrange the system without giving financial disadvantage for all of the consumer 10, the paper maker 13, the paper product manufacturer 14 and the retailer 15 according to the system.

As recycled paper products, there are copying paper, notebooks, packing tape and so on. A recycled paper use mark is generally used in Japan at present, and the consumer can visually determine whether the product uses recycled paper or not. However, the use of recycle paper use mark is not obligation, and the use is voluntary for manufacturers.

In the case where the consumer 10 produces discount value data when the retailer 15 sells a recycled paper product to the consumer 10, the retailer 15 sells the recycled paper product at a price discounted for the amount corresponding to the data.

The retailer 15 has a POS system 50 and collects sales management information by the POS system 50.

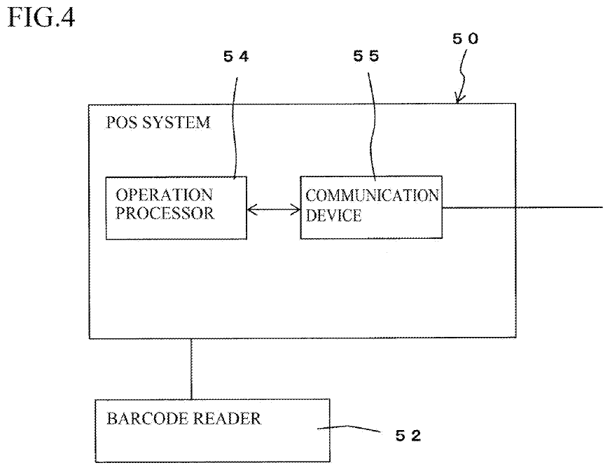

FIG. 4 shows an internal configuration of the POS system.

A barcode reader 52 is connected to the POS system 50, which can read a barcode attached to the product and the discount value data stored in the portable terminal 12 of the consumer 10.

An operation processor 54 and a communication device 55 are provided inside the POS system 50. The operation processor 54 can calculate the total amount or the like of the products read by the barcode reader 52 and makes a calculation of discounting the discount value amount from the total amount.

The communication device 55 can be connected to the server device 30 through Internet.

The retailer 15 reads discount value data by the barcode reader 52 when the consumer 10 produces the discount value data from the portable terminal 12 possessed by the consumer 10 at the time of purchasing the recycled paper product. The operation processor 54 of the POS system 50 calculates a discounted amount as the total amount by discounting an amount of the discount value data from the total amount of products desired to be purchased.

When the consumer 10 uses discount value data, the POS system 50 may notify the server device 30 that the consumer 10 has used the discount value data through the communication device 55.

The server device 30 can take actions such as increasing a discount rate for the consumer 10, for example, who has used the discount value data many times in a certain period.

A validity period may be set in the discount value data so that the data can be used any number of times during the validity period, or so that the data can be used only once during the validity period.

The present invention has been explained above in various ways by citing preferred embodiments, and it goes without saying that the present invention is not limited to this and many alterations may occur within a scope not departing from the gist of the invention.

What is claimed is:

1. A collecting system for old paper recyclable resources comprising:
a portable terminal possessed by a consumer;
a determination device for old paper recyclable resources having a weight sensor possessed by a collection trader of old paper recyclable resources for measuring the weight of old paper recyclable resources taken out by the consumer, a consumer data reading device reading consumer data for specifying the consumer that is affixed to the old paper recyclable resources taken out by the consumer, a paper string detection device detecting whether the old paper recyclable resources taken out by the consumer are bound with a special paper string with a special color or a special pattern and a data transmission device;
a server device connected to the portable terminal and the determination device for old paper recyclable resources so as to communicate; and
a POS system installed in a retailer,
wherein, when detecting that the old paper recyclable resources are bound with the special paper string by the paper string detection device, the determination device for old paper recyclable resources reads consumer data for at least specifying the consumer by the consumer data reading device and transmits weight data of old paper recyclable resources read by the weight sensor and consumer data read by the consumer data reading device to the server device so as to be associated with each other by the data transmission device,
the server device includes a storage device storing consumer data and weight data transmitted from the determination device for old paper recyclable resources so as to be associated with each other, a discount value calculating function calculating discount value data whereby a purchasing price is capable of being discounted when the consumer purchases any given product made by using recycled paper based on weight data, and a discount value data transmission device transmitting discount value data calculated by the discount value calculating function to the portable terminal of a corresponding consumer, and
the POS system reads recycled paper use information when the consumer purchases any given product made by using recycled paper to which the recycled paper use information is attached as well as reads discount value data transmitted to the portable terminal possessed by the consumer to thereby operate to make a discount on a purchase amount of the product to which recycled paper use information is attached based on the discount value data.

2. The collecting system for old paper recyclable resources according to claim 1, wherein the given products include the special paper string.
